(19) United States
(12) Patent Application Publication
(10) Pub. No.: US 2024/0025071 A1
(43) Pub. Date: Jan. 25, 2024

(54) FOOD CUTTER AND METHOD OF CUTTING FOOD

(71) Applicant: McCain Foods Limited, Florenceville- Bristol (CA)

(72) Inventors: David M. Rogers, Skiff Lake (CA); John Warren Aikens, New Maryland (CA)

(21) Appl. No.: 18/376,653

(22) Filed: Oct. 4, 2023

Related U.S. Application Data
(63) Continuation of application No. PCT/CA2022/050502, filed on Apr. 1, 2022.
(60) Provisional application No. 63/171,420, filed on Apr. 6, 2021.

(51) Int. Cl. B26D 1/143; B26D 1/24

(52) U.S. Cl. CPC B26D 1/143; B26D 1/24; B26D 2001/0053

(57) ABSTRACT

A food cutter has a food travel axis, a blade carrier, and a plurality of disc blades mounted to the blade carrier. Each of the plurality of disc blades defines a corresponding blade rotation axis. Each disc blade is rotatable relative to the blade carrier about the corresponding blade rotation axis, which is perpendicular to and offset from the food travel axis. Each disc blade has a perimeter edge at a constant radius from the corresponding blade rotation axis. The perimeter edge of each disc blade has a series of alternating peaks and valleys, which have an amplitude in a direction parallel to the corresponding blade rotation axis. Other methods and apparatus are also disclosed.

### CROSS-REFERENCE TO RELATED APPLICATIONS

This application is a continuation of International Application No. PCT/CA2022/050502 filed Apr. 1, 2022, which claims the benefit of U.S. Provisional Application No. 63/171,420 filed Apr. 6, 2021, the entire contents of which are incorporated herein by reference.

### FIELD

This application relates to the field of methods and apparatus for cutting food, such as fruit or vegetables.

### INTRODUCTION

Many manufacturers, restaurants, and individual consumers cut food and other products into shapes that satisfy their needs. For example, these entities may cut potatoes into sticks in order to produce French fries. The speed and consistency in cutting these products into such shapes may be improved by a food cutter.

### SUMMARY

In one aspect, a food cutter is provided. The food cutter has a food travel axis. The food cutter may comprise a blade carrier and a plurality of disc blades mounted to the blade carrier. Each of the plurality of disc blades may define a corresponding blade rotation axis. Each disc blade may be rotatable relative to the blade carrier about the corresponding blade rotation axis. The corresponding blade rotation axis of the disc blade may be perpendicular to and offset from the food travel axis. Each disc blade may have a perimeter edge at a constant radius from the corresponding blade rotation axis. The perimeter edge of each disc blade may have a series of alternating peaks and valleys. Each peak and valley may have an amplitude in a direction parallel to the corresponding blade rotation axis.

In another aspect, a food cutter is provided. The food cutter has a food travel axis. The food cutter may comprise a blade carrier and a plurality of disc blades mounted to the blade carrier. Each of the plurality of disc blades defining a corresponding blade rotation axis. Each disc blade may be rotatable relative to the blade carrier about the corresponding blade rotation axis. The corresponding blade rotation axis of the disc blade may be perpendicular to and offset from the food travel axis. Each disc blade may have a perimeter edge at a constant radius from the corresponding blade rotation axis. Each of the plurality of disc blades may have a corresponding incision axis that may be parallel to the food travel axis and tangent to the perimeter edge of the disc blade. The incision axis of each of the plurality of disc blades may be substantially collinear with the incision axis of at least one other of the plurality of disc blades.

In another aspect, a method of cutting food into food pieces is provided. The method may comprise:
moving a food item in a downstream direction along a food travel axis toward a plurality of rotatable disc blades,
   wherein the food item strikes the plurality of disc blades, wherein each disc blade defines a corresponding blade rotation axis;
   wherein each disc blade penetrates the food item,
   each disc blade having a perimeter edge with a series of alternating peaks and valleys, each peak and valley having an amplitude in a direction parallel to the corresponding blade rotation axis,
moving the food item downstream through the plurality of disc blades,
   wherein each disc blade in the plurality of disc blades is rotated as the food item moves through the plurality of disc blades; and
cutting the food item into food pieces by incisions made by the plurality of disc blades by moving the food item through the plurality of disc blades.

In another aspect, a method of cutting food into food pieces is provided. The method may comprise:
moving a food item in a downstream direction along a food travel axis toward a plurality of rotatable,
   wherein the food item strikes the plurality of disc blades, wherein each disc blade defines a corresponding blade rotation axis,
   wherein each disc blade penetrates the food item,
   wherein each disc blade has a perimeter edge at a constant radius from a blade rotation axis;
moving the food item downstream through the plurality of disc blades; and
cutting the food item into food pieces by incisions made by the plurality of disc blades by moving the food item through the plurality of disc blades, each disc blade forming an incision in the food item with a terminal end in an interior of the food item, and the terminal end of each incision abutting the terminal end of an incision formed by at least one other of the plurality of disc blades.

### DRAWINGS

FIG. 1 shows a schematic diagram of a hydraulic cutting system, in accordance with an embodiment;

FIG. 2 is a partial perspective view (with a portion of the conduit removed for clarity) showing an embodiment of a food cutter within a conduit of a hydraulic cutting system, in accordance with an embodiment;

FIG. 3 shows a perspective view of the food cutter of FIG. 2 alongside a whole potato and potato pieces cut by the food cutter, in accordance with an embodiment;

FIG. 4 shows a front view of a disc blade with an axle, in accordance with an embodiment;

FIG. 5 shows a side view of the disc blade of FIG. 4;

FIG. 6 shows a perspective view of the disc blade of FIG. 4;

FIG. 7 shows a front view of the food cutter of FIG. 2;

FIG. 8 shows a perspective view of the food cutter of FIG. 2;

FIG. 9 shows a partially exploded perspective view of the food cutter of FIG. 2;

FIG. 10 shows a perspective view of a food cutter, alongside a whole potato, a potato slice, and a potato stick, in accordance with another embodiment;

FIG. 11 shows a front view of a food cutter in accordance with another embodiment;

FIG. 12 shows a perspective view of the food cutter of FIG. 12;

FIG. 13 shows a cross-sectional view taken along line 13-13-in FIG. 11;

FIGS. 14-15 show an arrangement of blades for a food cutter in accordance with another embodiment;

FIG. 16 shows an arrangement of blades for a food cutter in accordance with another embodiment;

FIG. 17 shows an arrangement of blades for a food cutter in accordance with another embodiment;

FIG. 18 shows an arrangement of blades for a food cutter in accordance with another embodiment; and

FIG. 19 shows a cross-sectional view of a food cutter in accordance with another embodiment.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a first element is said to be ‘communicatively coupled to’ or ‘communicatively connected to’ or ‘connected in communication with’ a second element where the first element is configured to send or receive electronic signals (e.g. data) to or from the second element, and the second element is configured to receive or send the electronic signals from or to the first element. The communication may be wired (e.g. the first and second elements are connected by one or more data cables), or wireless (e.g. at least one of the first and second elements has a wireless transmitter, and at least the other of the first and second elements has a wireless receiver). The electronic signals may be analog or digital. The communication may be one-way or two-way. In some cases, the communication may conform to one or more standard protocols (e.g. SPI, I²C, Bluetooth™′ or IEEE™ 802.11).

As used herein and in the claims, a group of elements are said to ‘collectively’ perform an act where that act is performed by any one of the elements in the group, or performed cooperatively by two or more (or all) elements in the group.

As used herein and in the claims, a first line or axis is said to be “perpendicular” to a second line or axis in three dimensional space when the second line or axis is parallel to or collinear with an imaginary line that intersects the first line at a 90 degree angle, or within an angle of about 5 degrees of parallel to or collinear with the imaginary line.

As used herein and in the claims, an element is said to be ‘free rotating’ or ‘freely rotatable’ where that element is not drivingly coupled to (e.g. directly drivingly connected to, or indirectly drivingly coupled by way of gears, chains, cords, belts, or other means) a rotary driver (e.g. an electric, pneumatic, hydraulic, or combustion-powered motor, an engine, or a cylinder).

Some elements herein may be identified by a part number, which is composed of a base number followed by an alphabetical or subscript-numerical suffix (e.g. 112a, or 112₁). Multiple elements herein may be identified by part numbers that share a base number in common and that differ by their suffixes (e.g. 112₁, 112₂, and 112₃). All elements with a common base number may be referred to collectively or generically using the base number without a suffix (e.g. 112).

For convenience, the description below will refer to potatoes as the food item being cut. Those skilled in the art will appreciate that the embodiments of a cutter and methods of cutting described herein may be used to cut any suitable product, including without limitation food items (such as fruits and vegetables), wood, and fibrous materials (such as bamboo). Some examples of vegetables include tubers (e.g. potatoes, taro, artichokes, yams, and ginger).

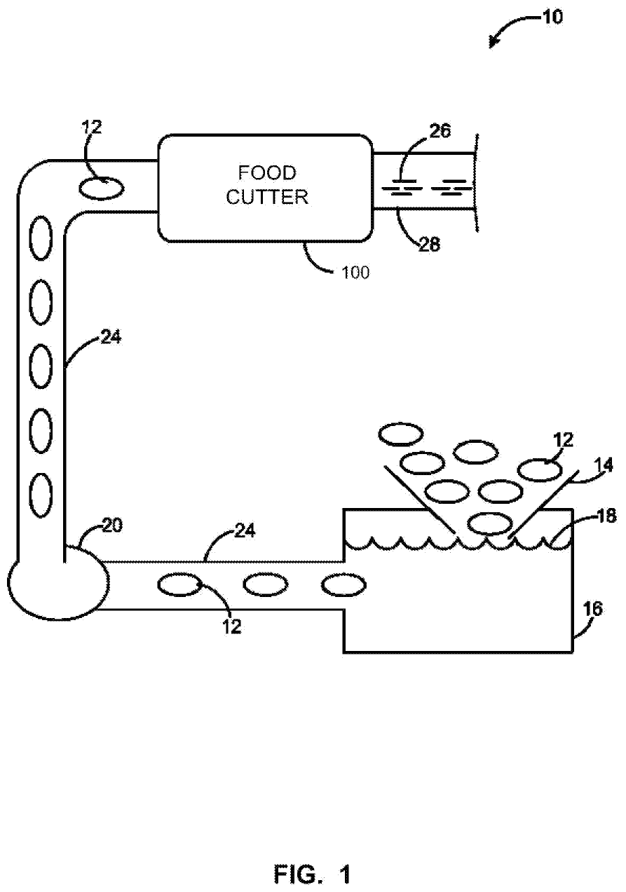

FIG. 1 shows a schematic view of a hydraulic cutting system 10, in accordance with at least one embodiment. In the example shown, potatoes 12 are fed from a hopper 14 into a tank 16 in which they are submersed in water 18. As shown, a plurality of conduits 24 connect tank 16 to a pump 20, and pump 20 to a food cutter 100.

In some embodiments, pump 20 circulates water 18 from tank 16 to thereby entrain potatoes 12 to travel through conduits 24 to food cutter 100. Conduits 24 may be sized to receive potatoes 12 in single file. For example, conduits (e.g. pipes) 24 may have a diameter that is greater than a diameter of potatoes 12, and less than the diameter of two potatoes 12.

In the example shown, potatoes 12 travel through conduits 24 toward food cutter 100 at a velocity imparted to them by pump 20. Food cutter 100 is described in detail below. As potatoes 12 travel through food cutter 100, they are cut into smaller pieces 26 and discharged through outlet conduit 28. Optionally, potato pieces 26 are subjected to subsequent processing (e.g. cooking, parfrying, freezing, packaging etc.). In some embodiments, potatoes 12 are raw potatoes, and potato pieces 26 are sticks or wedges processed into frozen or fresh, cooked or par-cooked, French fries or potato wedges.

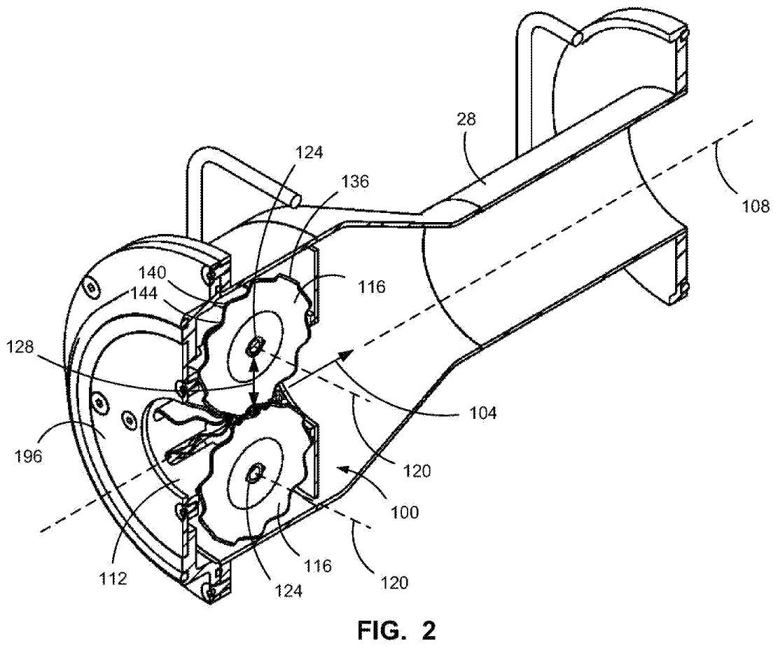

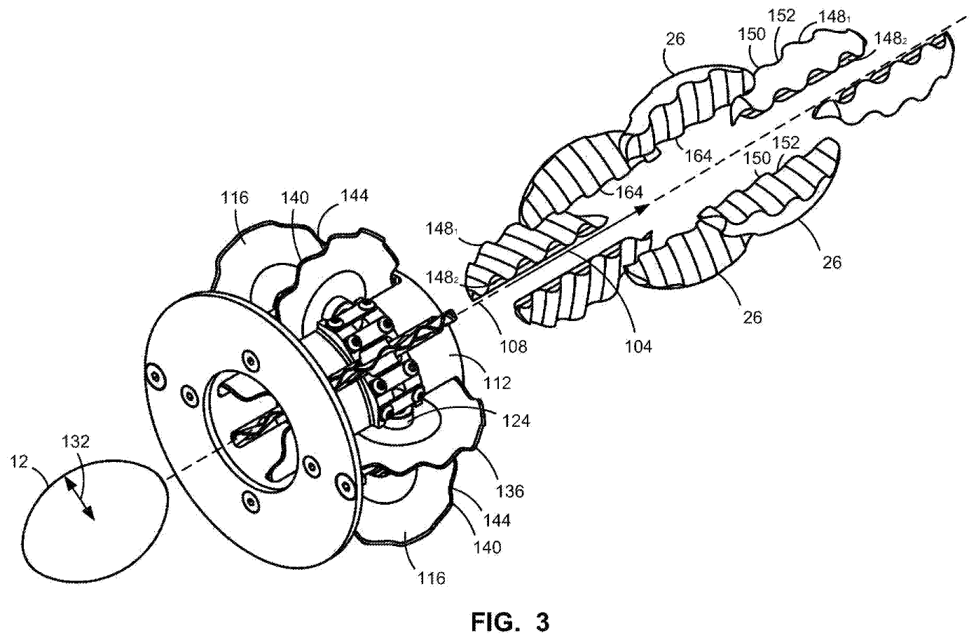

Reference is now made to FIGS. 2-3, in which FIG. 2 shows an embodiment of food cutter 100 secured within a section of conduit 28, and FIG. 3 shows a whole potato 12 traveling in a downstream direction 104 along a food travel axis 108 towards food cutter 100, and downstream potato pieces 26 that were cut by food cutter 100.

As shown, food cutter 100 may include a blade carrier 112 and a plurality of disc blades 116 mounted to the blade carrier 112. Each disc blade 116 is rotatably mounted to blade carrier 112 and has a respective blade rotation axis 120. The blade rotation axis 120 of each disc blade 116 is perpendicular to and offset from the food travel axis 108 (and the downstream direction 104). This may permit a potato 12 to move through disc blades 116 without striking the axle or other structural member that rotatably mounts the disc blade 116 to blade carrier 112. For example, in some embodiments, each disc blade 116 may be rotatably mounted to blade carrier 112 on a blade axle 124, and the minimum distance 128 between each blade axle 124 and the food travel axis 108 may be at least as large as the radius 132 of the potatoes 12 delivered to food cutter 100.

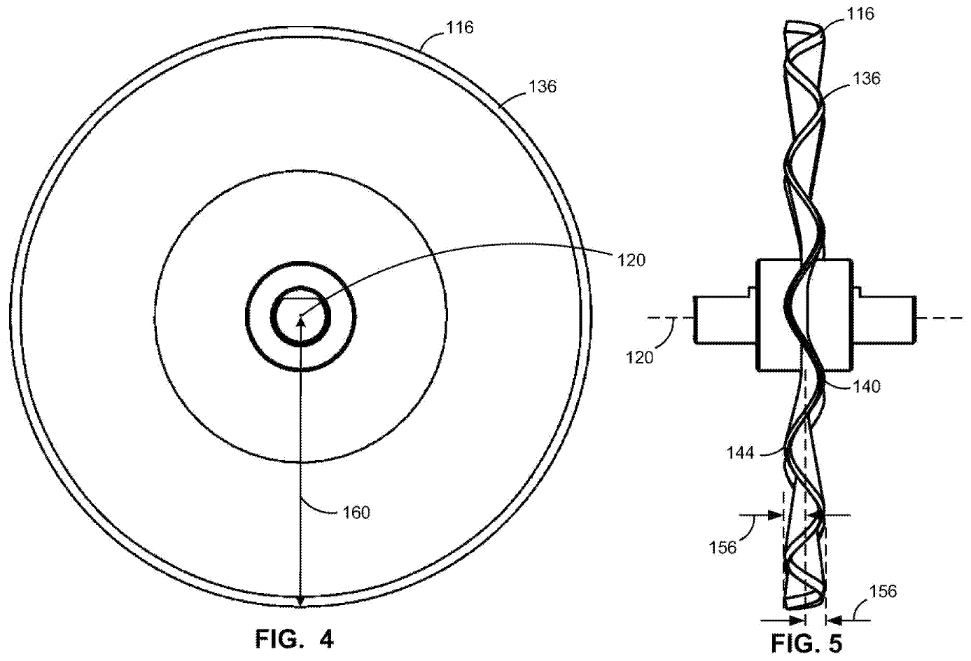

Referring to FIGS. 4-6, each disc blade 116 has a perimeter edge 136. In some embodiments, the perimeter edge 136 may have a wavy profile including a series of alternating peaks 140 and valleys 144. As shown, each peak 140 and valley 144 may define a respective amplitude 156 in a direction parallel to the blade rotation axis 120 of that disc blade 116. This wavy profile on perimeter edge 136 may allow the disc blade 116 to form incisions in potatoes that have a wavy profile with corresponding peaks and valleys. For example, FIG. 3 shows potato pieces 26, each with cut faces 148₁ and 148₂ that have a wavy profile defined by the peaks 140 and valleys 144 of the disc blades 116 that cut those face 148₁, 148₂. As shown, the wavy profile of each cut face 148₁ and 148₂ may include peaks 150 and valleys 152 that alternate in the downstream direction 104.

Returning to FIGS. 4-6, the wavy profile of the blade perimeter edge 136 may include a constant wavelength 154 (i.e. constant circumferential distance between sequential peaks 140 or between sequential valleys 144) as shown. This may permit disc blades 116 to form incisions into potatoes 12 with a wavy profile having a more uniform wavelength. Alternatively, the wavy profile of the blade perimeter edge 136 may include a variable wavelength. That is, there may be two or more different wavelengths in the wavy profile of blade perimeter edge 136. In some examples, a blade perimeter edge 136 may have a wavy profile with a wavelength 154 of 5 mm to 50 mm.

In some embodiments, all peaks 140 and valleys 144 may have the same amplitude 156 measured parallel to the blade rotation axis 120, as shown. In alternative embodiments, one or more (or all) valleys 144 may have a different amplitude 156 than one or more (or all) peaks 140. Furthermore, peaks 140 may have all the same amplitude 156 or there may be one or more (or all) peaks 140 with a different amplitude 156 than one or more (or all) other peaks 140. Similarly, valleys 144 may have all the same amplitude 156 or there may be one or more (or all) valleys 144 with a different amplitude 156 than one or more (or all) other valleys 144. In some examples, peaks 140 and valleys 144 may have an amplitude of 1 mm to 30 mm.

Still referring to FIGS. 4-6, peaks 140 and valleys 144 may have a curved waveform as shown (e.g. a sinusoidal waveform). In other embodiments, peaks 140 and valleys 144 may have another regular or irregular waveform, such as for example a square, triangle, sawtooth, or tidal waveform. The waveform of each peak 140 and valley 144 may be constant around the blade perimeter edge 136 as shown. In other embodiments, one or more (or all) valleys 144 may have a different waveform than one or more (or all) peaks 140. Furthermore, peaks 140 may have all the same waveform (as shown) or there may be one or more (or all) peaks 140 with a different waveform than one or more (or all) other peaks 140. Similarly, valleys 144 may have all the same waveform (as shown) or there may be one or more (or all) valleys 144 with a different waveform than one or more (or all) other valleys 144.

Disc blades 116 may all have the same blade radius 160, as shown. In other embodiments, one or more (or all) disc blades 116 may have a different blade radius 160 than one or more (or all) other disc blades 116. In some examples, blade radius 160 may be between 10 mm and 300 mm.

The perimeter edge 136 of each disc blade 116 may have the same number of peaks 140 and valleys 144 as each other disc blade 116. For example, disc blades 116 may all have the same blade radius 160 and a wavy profile with the same wavelength 154, as shown. This may permit the disc blades 116 to form incisions that have the same or very similar wavy profiles. In some examples, a disc blade 116 may have 4 to 40 peaks and the same number of valleys (plus or minus one).

In other embodiments, one or more (or all) of disc blades 116 may have a different blade radius 160 and wavy profile with a different wavelength 154 than one or more (or all) other disc blades 116, and yet have the same number of peaks 140 and valleys 144 as the one or more (or all) other disc blades 116.

Alternatively, the perimeter edge 136 of one or more (or all) disc blades 116 may have a different number of peaks 140 and valleys 144 than one or more (or all) other disc blades 116. This may permit the disc blades 116 to form incisions that have differing wavy profiles.

In alternative embodiments, the blade perimeter edge 136 of each disc blade 116 is flat—i.e. it has no wavy profile.

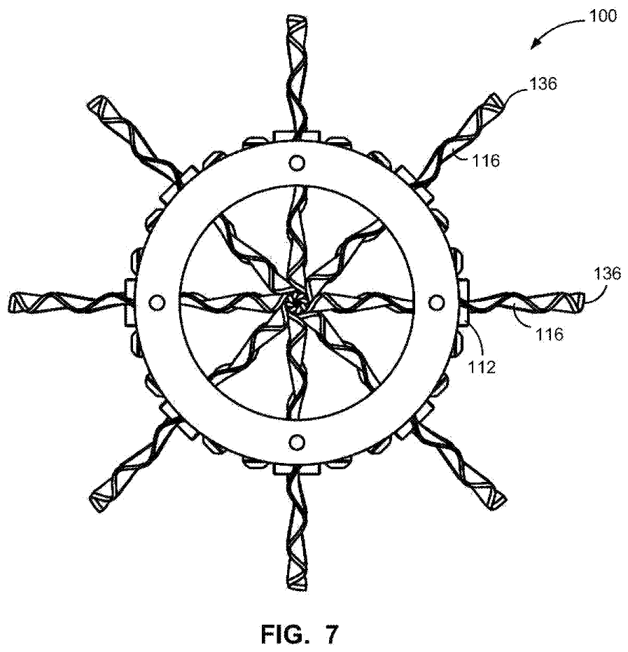

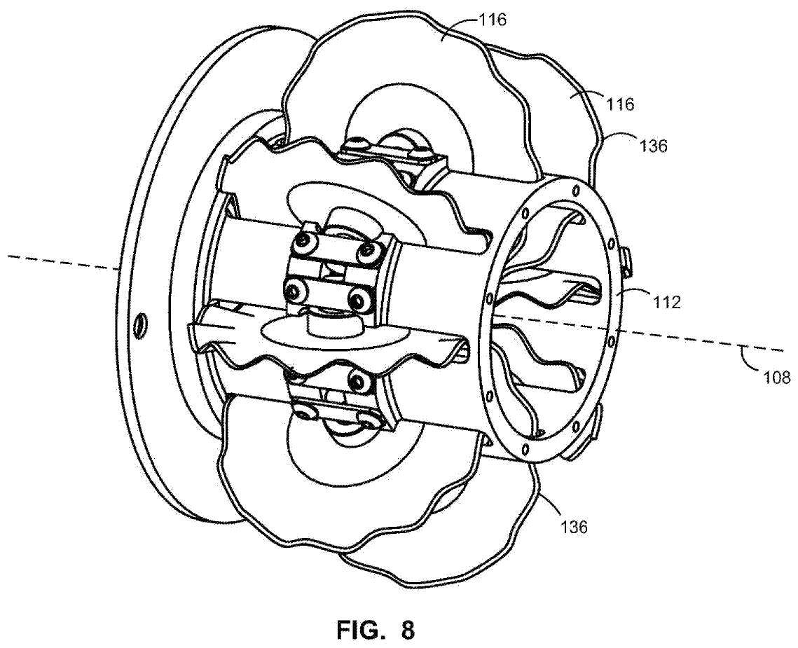

Referring to FIG. 4, each disc blade 116 may have a perimeter edge 136 at a constant radius 160 from the blade rotation axis 120 of that disc blade 116. As shown, a projection of the perimeter edge 136 parallel to the blade rotation axis 120 may form a circle. Turning to FIG. 7, the perimeter edge 136 of each disc blade 116 may abut the perimeter edge 136 of at least one other disc blade 116. In the illustrated embodiment where the disc blades 116 have a constant radius 160 (FIG. 4) from their respective blade rotation axes 120, their perimeter edges 136 can retain their abutting relationship with the perimeter edge 136 of at least one other disc blade 116 even as those disc blades 116 rotate.

As used herein and in the claims, a perimeter edge 136 of a disc blade 116 is said to “abut” the perimeter edge 136 of another disc blade 116 where the perimeter edges 136 of these two disc blades 116 are in physical contact with each other, or where the perimeter edges 136 of these two disc blades 116 are spaced apart by a distance of less than 2.5 mm or less than 5% of their combined blade radii 160 (FIG. 4). Two blades with perimeter edges 136 that abut may form two incisions that effectively combine to divide the potato into pieces. However, if the blade carrier 112 and blade radii 160 (FIG. 4) are dimensioned so that the perimeter edges 136 of two disc blades 116 are in physical contact, then manufacturing tolerances may cause the disc blades 116 to jam, thereby inhibiting their rotation. Accordingly, a very small gap may be permitted between abutting perimeter edges 136 without substantially affecting the quality of their combined incisions on passing potatoes.

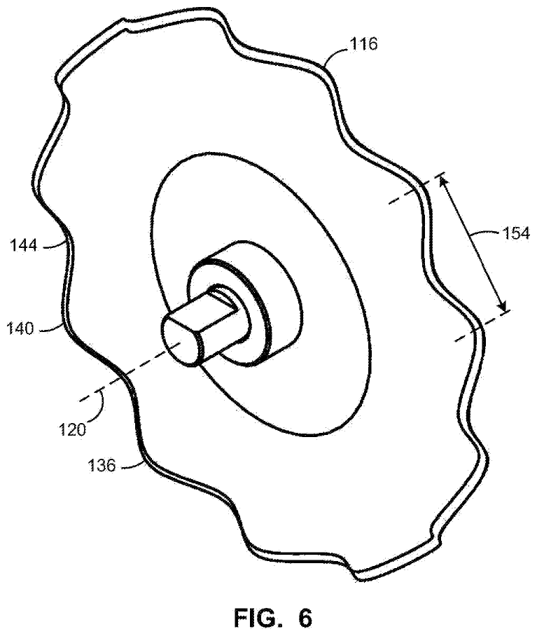

In alternative embodiments, the perimeter edge 136 of one or more (or all) disc blades 116 may not have a constant radius 160 from its blade rotation axis 120 (FIG. 6). For example, the perimeter edge 136 of one or more (or all) disc blades 116 may be serrated or have a wavy profile with a radial amplitude.

Referring to FIGS. 2-3, each disc blade 116 may be freely rotatable relative to blade carrier 112 about their respective blade rotation axis 120, as shown. In use, disc blades 116 may be rotated relative to blade carrier 112 about their blade rotation axes 120 by their interaction with a potato 12 which is moving through food cutter 100. In embodiments where disc blades 116 have perimeter edges 136 with a wavy profile, the blade rotation speed (e.g. in revolutions per second, or equivalent) of each disc blade 116 may be governed by interaction between (i) the potato 12 and (ii) the peaks 140 and valleys 144 of each disc blade 116. Because the wavy profile creates a substantial thickness perpendicular to the food travel axis 108 and downstream direction 104 (i.e. measured parallel to the blade rotation axis 120), the potato 12 cannot pass through food cutter 100 without disc blades 116 being rotated. Indeed, the potato 12 may impart upon each disc blade 116 a rotation speed that is a function of the potato's speed (e.g. in feet per second, or equivalent):

ω_{blade}=f(vₚₒₜₐₜₒ) (Equation 1)

In Equation 1, ω_{blade} is the rotation speed of the disc blade 116, and vₚₒₜₐₜₒ is the speed of the potato 12 through food cutter 100.

For example, the rotation speed of a disc blade 116 as the potato passes through it may be such that the tangential speed of the disc blade 116 at its perimeter edge 136 is equal to the speed of the potato 12 through food cutter 100:

v_{tangent}=vₚₒₜₐₜₒ (Equation 2a)

ω_{blade}×Cₚₑᵣᵢₘₑₜₑᵣ=vₚₒₜₐₜₒ (Equation 2b)

ω_{blade}×2πr_{blade}=vₚₒₜₐₜₒ (Equation 2c)

ω_{blade}=vₚₒₜₐₜₒ/(2πr_{blade}) (Equation 2d)

In Equations 2a-d, v_{tangent} is the tangential speed of the disc blade 116 at its perimeter edge 136, Cₚₑᵣᵢₘₑₜₑᵣ is the circumference of the blade perimeter edge 136, and r_{blade} is blade radius 160.

The equality between the tangential speed of the disc blade 116 at its perimeter edge 136 and the speed of the potato 12 through food cutter 100 occurs naturally because of the interaction between (i) the potato 12 and (ii) the peaks 140 and valleys 144 of each disc blade 116. Specifically, the peaks 140 and valleys 144 that pierce the potato 12 at any given moment create an interference that inhibits the potato 12 from moving faster or slower than the tangential speed of the disc blade 116 at its perimeter edge 136. Since the disc blades 116 are freely rotatable, it is the speed of the potato 12 that governs the blade rotation speed.

In the result, the incisions made into a potato 12 from moving the potato through the food cutter 100 may be substantially consistent irrespective of the speed at which the potato 12 is traveling. For example, the potato pieces 26 cut from a slow moving potato 12 and the potato pieces 26 cut from a fast moving potato 12 may have faces 148 with substantially the same wavy profile (e.g. the same wavelength(s) and amplitude(s)). Accordingly, a hydraulic system 10 (FIG. 1) equipped with food cutter 100 may not need to precisely control the speed at which potatoes 12 are propelled through food cutter 100 to produce consistent results in the cut potato pieces 26.

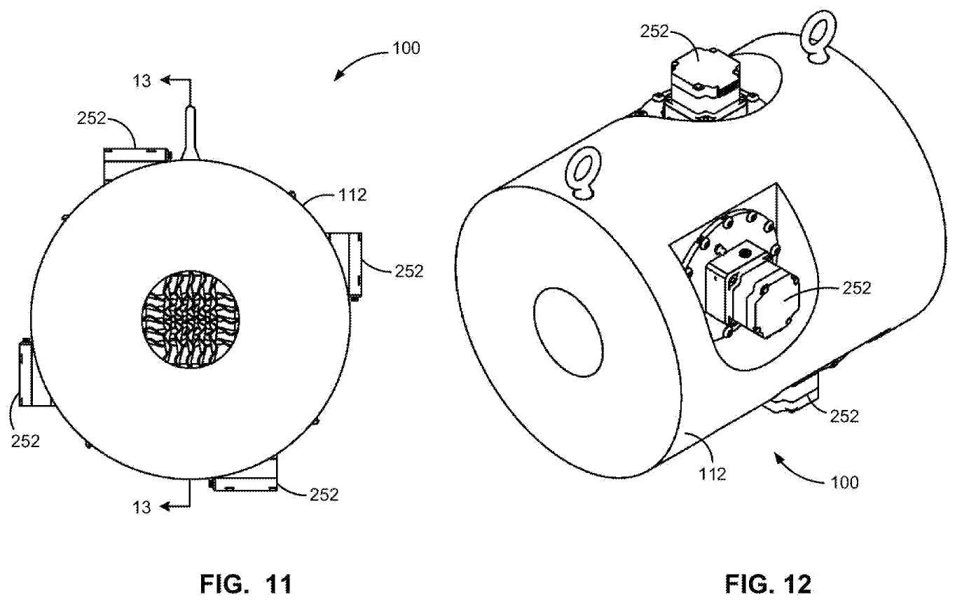

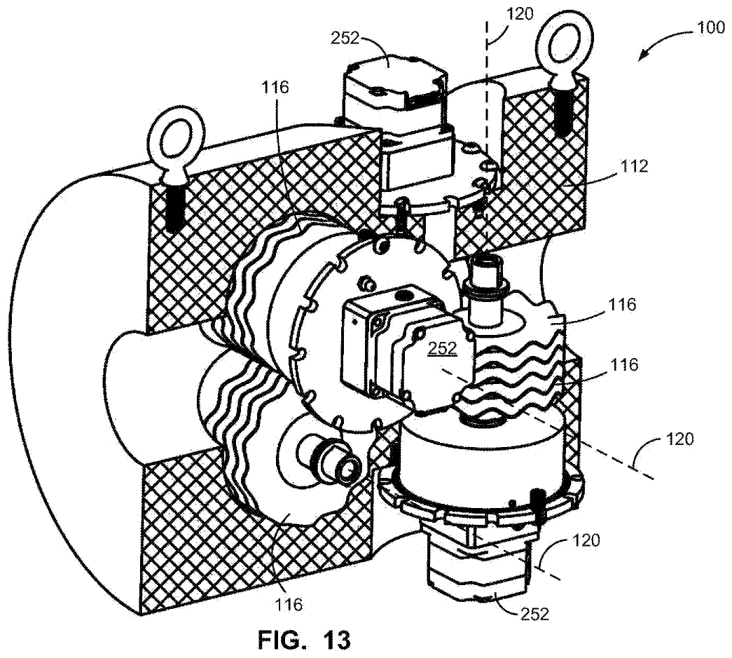

In alternative embodiments, one or more (or all) of disc blades 116 are not free rotating, and instead are drivingly coupled to (e.g. directly drivingly connected to, or indirectly drivingly coupled by way of gears, chains, cords, belts, or other means) a rotary driver (e.g. electric, pneumatic, hydraulic, or combustion-powered motor, engine, or cylinder) to drive its rotation. For example, FIGS. 11-13 show an embodiment food cutter 100 that includes rotary drivers 252 (depicted as electric motors), which are drivingly coupled to disc blades 116. This allows rotary drivers 252 (which themselves may be controlled by a computer system) to dictate the rotation speed of disc blades 116 about their blade rotation axes 120 (FIG. 13).

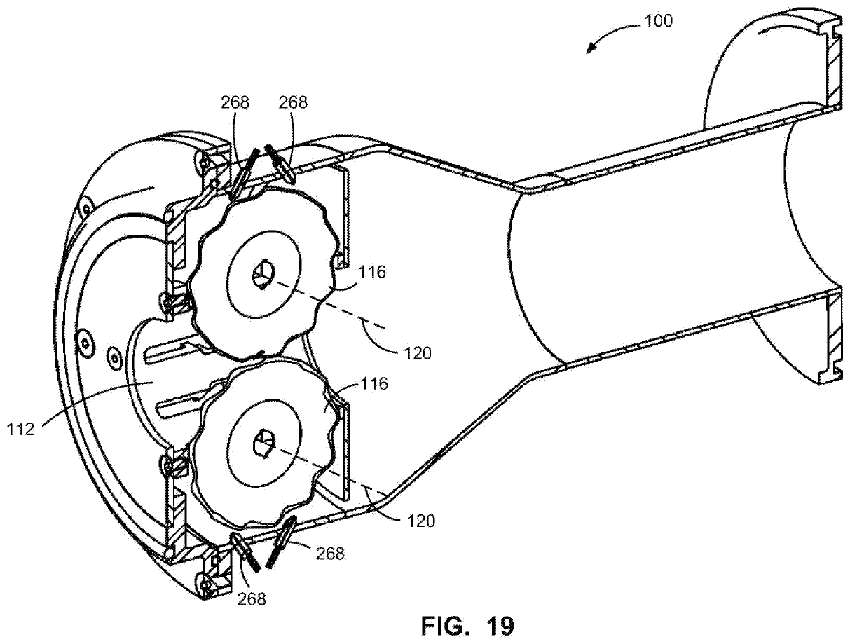

FIG. 19 shows another embodiment of food cutter 100. For clarity of illustration, blade axles 124 and some disc blades 116 are not shown. In some embodiments, food cutter 100 may include one or more fluid jets 268. Each fluid jet 268 may be positioned and oriented to direct fluid (gas or liquid) at a disc blade 116 to reduce, increase, stop, or maintain the rotational speed of that disc blade 116 about its rotation axis 120. In the illustrated example, each disc blade 116 has associated with it two corresponding fluid jets 268. The two jets 268 are oriented in different directions so that fluid from the two jets 268 can apply rotational force to accelerate the disc blade 116 in different rotational directions (i.e. one clockwise and the other counterclockwise). In other embodiments, a disc blade 116 may have associated with it just one jet 268, or three or more jets 268.

Referring to FIGS. 7-8, blade carrier 112 can have any configuration that allows the plurality of disc blades 116 to be rotatably mounted and rotatable about respective blade rotation axes 120 (FIG. 2) that are offset from and perpendicular to food travel axis 108.

In some embodiments, blade carrier 112 may carry disc blades 116 in a circular arrangement surrounding food travel axis 108. The circular arrangement may accommodate any number of disc blades 116. For example, blade carrier 112 may hold three or more (e.g. 3-100) disc blades 116 in a circular arrangement. The illustrated embodiment includes eight disc blades 116. Disc blades 116 may be evenly distributed about the circular arrangement as shown. For example, disc blades 116 may be mounted to blade carrier 112 at positions that are evenly distributed along an imaginary circle that surrounds food travel axis 108.

As shown, the perimeter edge 136 of each disc blade 116 may abut the perimeter edge 136 of each other disc blade 116. This allows the incisions formed by the disc blades 116 to combine to cleanly divide the potato 12 (FIG. 3) into pieces 26 (FIG. 3). In the illustrated example, the perimeter edge 136 of each disc blade 116 abuts food travel axis 108. Turning to FIG. 3, the incision formed by a disc blade 116 may have a terminal end within an interior of the potato 12. That is, the depth of each incision may be less than the total depth of the potato 12 where that incision is made, and each individual incision may be insufficient to divide the potato 12 into pieces 26. Instead, the terminal end of each incision may abut the terminal end at least one other incision, and these abutting incisions may jointly divide off a potato piece 26 from the potato 12. In the illustrated example, the terminal end of each incision will coincide with food travel axis 108.

By way of example, a food cutter 100 with a circular arrangement of disc blades 116 with perimeter edges 136 that all abut food travel axis 108 may operate to divide potatoes 12 into potato wedges 26. As shown, each wedge 26 may have a pair of faces 148₁, 148₂ that were cut by incisions formed by different disc blades 116. Wedge faces 148₁, 148₂ may intersect at a wedge apex 164. At the time of cutting potato 12 into potato wedges 26, wedge apex 164 may represent the location where the terminal ends of the corresponding incisions (formed by the two different disc blades 116 which cut faces 148₁, 148₂) abutted. In some cases, wedge apex 164 may be aligned with (e.g. collinear with) food travel axis 108 during the period in which potato 12 is being cut by food cutter 100.

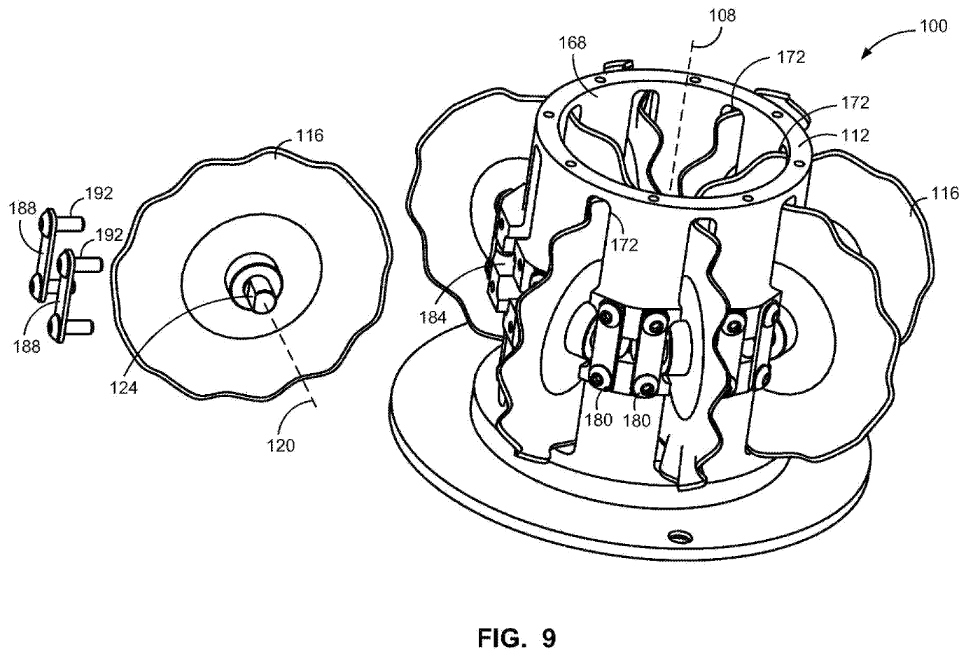

Referring to FIG. 9, each disc blade 116 may be mounted to blade carrier 112 in any manner that allows the disc blade 116 to rotate about a blade rotation axis 120 (FIG. 2) offset from and perpendicular to food travel axis 108. The illustrated example shows blade carrier 112 including a cylindrical body 168. A blade slot 172 for each disc blade 116 is formed in cylindrical body 168. Each of the blade slots 172 is sized to accommodate a respective disc blade 116 without interfering with the free rotation of the disc blade 116.

An axle 124 may be connected to each disc blade 116. Each axle 124 may define the blade rotation axis 120 of the connected disc blade 116. In some embodiments, a bearing 176 (e.g. roller bearing or bushing) may be interposed between each disc blade 116 and the corresponding blade axle 124. This may help reduce frictional resistance to the rotation of each disc blade 116 about its blade rotation axis 120. Alternative embodiments may not include bearings 176.

Two axle retainers 180 may flank each blade slot 172 to fix the position of the blade axle 124 of the disc blade 116 received in that blade slot 172. Axle retainers 180 may have any design suitable for maintaining the position of the blade axle 124. In some embodiments, the blade axle 124 may be permitted to rotate. In the illustrated embodiment, blade axle 124 is inhibited from rotating when connected to axle retainers 180. As shown, each axle retainer 180 may include a recess 184 to receive one end of a blade axle 124, and a movable (e.g. removable or rotatable) cover 188. Cover 188 may be positioned over recess 184 to hold blade axle 124 within recess 184, and may be movable (e.g. removable or rotatable) from recess 184 to allow the blade axle 124 to be removed. For example, blade axle 124 may be removed to remove the connected disc blade 116 for repair (e.g. sharpening) or replacement. Cover 188 may be connected to axle retainer 180 in any manner, such as by fasteners 192 (e.g. screws, bolts, or rivets).

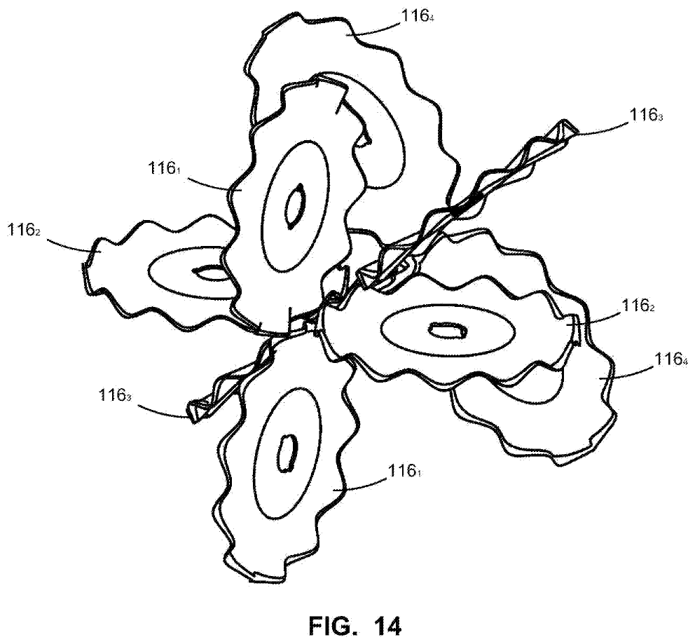

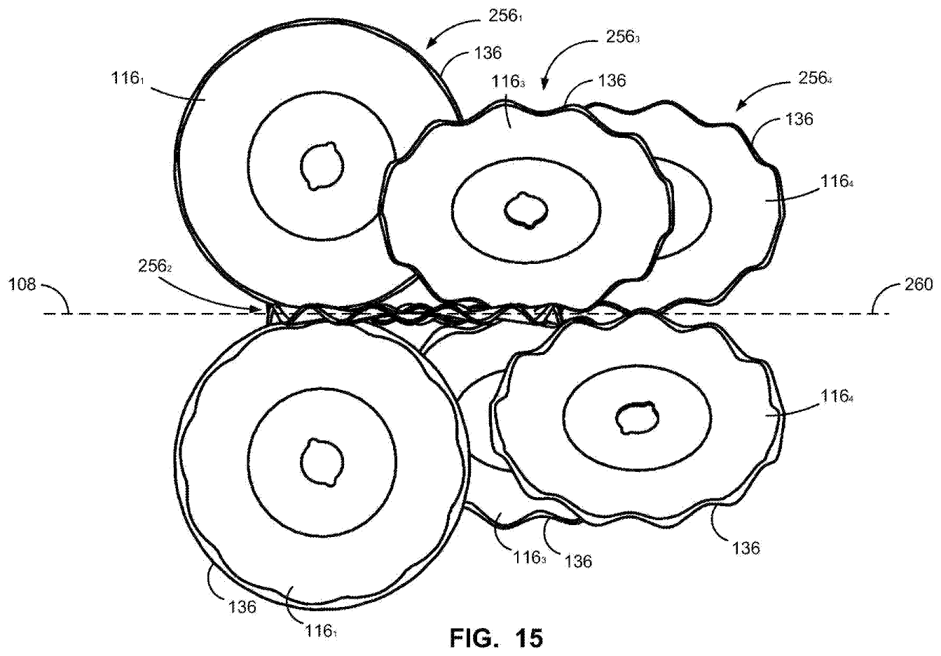

FIGS. 14-15 show an arrangement of disc blades 116 for another embodiment of food cutter 100 (FIG. 1). The disc blade carrier and blade axles are not shown to avoid obscuring the visibility of disc blades 116. As shown, in some embodiments, one or more (or all) of disc blades 116 may be positioned downstream or upstream (i.e. offset in a direction parallel to food travel axis 108) of one or more (or all) of the other disc blades 116.

In some embodiments, food cutter 100 may include two or more groups 256 of disc blades 116, each group 256 of disc blades 116 may be offset upstream or downstream from the other groups 256 of disc blades 116. Within each group 256, there may be at least two disc blades 116 having abutting blade perimeter edges 136. This allows each group of disc blades 116 to form substantially intersecting incisions in a food item to divide the food item into pieces. In the illustrated embodiment, there are four groups 256₁-256₄ each having two respective disc blades 116₁-116₄.

In some embodiments, an upstream disc blade 116 and a downstream disc blade 116 may cooperate to form incisions that substantially intersect in a food item to divide the food item into pieces. For example, each disc blade 116 may have an incision axis 260 parallel to food travel axis 108 and tangent to the blade perimeter edge 136 of that disc blade 116. The incision axes 260 of an upstream disc blade 116 and a downstream disc blade 116 may be substantially collinear. For example, the incision axis 260 of the upstream disc blade 116 may be parallel to and abutting the incision axis 260 of the downstream disc blade 116 (e.g. less than 2.5 mm apart or less than 5% of their combined blade radius). In some examples, the incision axis 260 of the upstream and downstream blades 116 may abut the food travel axis 108. As shown, the incision axis 260 of the upstream and downstream blades 116 may be collinear with food travel axis 108.

Referring to FIGS. 7-8, in some embodiments, one or more of disc blades 116 may be configured to only score a food item instead of cooperating with one or more other disc blades 116 to divide the food item into pieces. For example, one or more disc blades 116 may have a perimeter edge 136 that is spaced apart from food travel axis 108. Referring to FIGS. 14-15, in some embodiments, one or more disc blades 116 may have an incision axis 260 that is spaced apart from (i.e. that is not substantially collinear with) the incision axis 260 of all other disc blades 116.

Referring to FIG. 2, in some embodiments blade carrier 112 may include a mount 196 for securing food cutter to other equipment, such as a hydraulic cutting system 10 (FIG. 1). In the illustrated example, mount 196 includes a mounting flange for securing food cutter 100 to a conduit 28 of hydraulic cutting system 10 (FIG. 1).

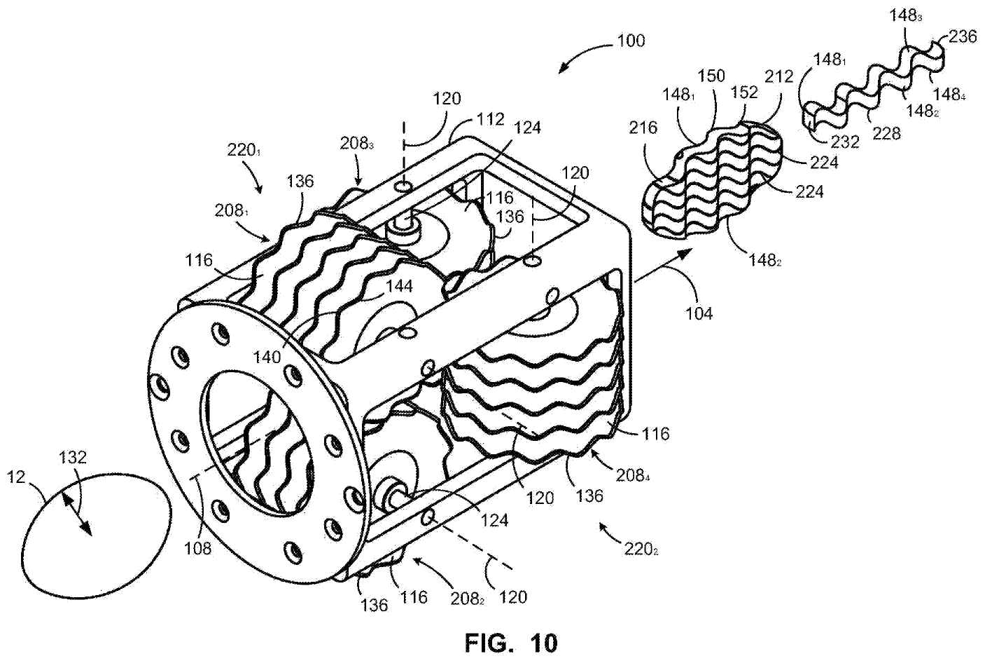

Reference is now made to FIG. 10, which shows a food cutter 100 in accordance with another embodiment. As shown, food cutter 100 may include a blade carrier 112 to which several rows 208 of disc blades 116 are mounted. Within each row 208 of disc blades 116, every disc blade 116 is rotatable about a common blade rotation axis 120. That is the blade rotation axis 120 of each disc blade 116 within a row 208 of disc blades 116 is collinear with the blade rotation axis 120 of each other disc blade 116 within that row 208 of disc blades 116. The blade rotation axes 120 of all disc blades 116 may be perpendicular to and offset from food travel axis 108 as shown.

Food cutter 100 may include at least two rows 208 of disc blades 116. For example, food cutter 100 may include at least a first row 208₁ and a second row 208₂. As shown, the perimeter edge 136 of each disc blade 116 in the first row 208₁ of disc blades 116 may abut the perimeter edge 136 of a respective disc blade 116 in the second row 208₂ of disc blades 116. For example, the first and second rows 208₁, 208₂ may have an equal number disc blades 116, and each disc blade 116 in the first row 208₁ may be aligned with a respective disc blade 116 in the second row 208₂ so that their perimeter edges 136 abut.

In some embodiments, the common blade rotation axis 120 of the disc blades 116 in the first row 208₁ is parallel to and offset from the common blade rotation axis 120 of the disc blades 116 in the second row 208₂. As shown, the first and second rows 208₁, 208₂ of disc blades 116 may flank food travel axis 108 so that potatoes 12 move between them. For example, food travel axis 108 may lie between the common blade rotation axis 120 of the disc blades 116 of the first row 208₁ of disc blades 116, and the common blade rotation axis 120 of the disc blades 116 of the second row 208₂ of disc blades 116.

The minimum distance between each blade axle 124 (or it may be one common blade axle as shown) of the disc blades 116 in the first row 208₁ and the food travel axis 108 may be at least as large as the radius 132 of the potatoes 12 delivered to food cutter 100. Similarly, the minimum distance between each blade axle 124 (or it may be one common blade axle as shown) of the disc blades 116 in the second row 208₂ and the food travel axis 108 may be at least as large as the radius 132 of the potatoes 12 delivered to food cutter 100.

Still referring to FIG. 10, in use, when a potato 12 is moved (e.g. hydraulically propelled) through food cutter 100, the disc blades 116 of the first and second rows 208₁, 208₂ of disc blades 116 may divide the potato into food slices 212. Only one food slice 212 is shown for clarity. As shown, food slice 212 may be formed as a patty with a first cut face 148₁ spaced apart from a second cut face 148₂ by a natural (i.e. uncut by incisions formed by disc blades 116) exterior face 216 which surrounds faces 148₁, 148₂. Each of faces 148₁, 148₂ was made by the combined incisions of a disc blade 116 from the first row 208₁ and a disc blade 116 from the second row 208₂. Further, each of faces 148₁, 148₂ has a wavy profile defined by the peaks 140 and valleys 144 of the disc blades 116 that cut that face 148₁ or 148₂. As shown, the wavy profile of each cut face 148₁ and 148₂ may include peaks 150 and valleys 152 that alternate in the downstream direction 104.

In some embodiments, food cutter 100 may include additional rows 208 of disc blades 116. In the illustrated example, food cutter 100 includes a first plurality 220₁ of disc blades 116, and a second plurality 220₂ of disc blades 116 positioned downstream of the first plurality 220₁. The first plurality 220₁ includes the first and second rows 208₁ and 208₂ of disc blades 116. The second plurality 220₂ includes a third and fourth row 208₃, 208₄ of disc blades 116.

The second plurality 220₂ of disc blades may be characteristically similar to the first plurality 220₁. The description above of the first plurality 220₁, including the description of the first and second rows 208₁, 208₂, may apply to the second plurality 220₂ and its third and fourth rows 208₃, 208₄.

In some embodiments, the blade rotation axes 120 of the second plurality 220₂ of disc blades may be non-parallel to the blade rotation axes 120 of the first plurality 220₁. For example, the blade rotation axes 120 of the second plurality 220₂ may be perpendicular to the blade rotation axes 120 of the first plurality 220₁. This allows the second plurality 220₂ to form incisions 224 that are non-parallel (e.g. substantially perpendicular) to the incisions formed by the first plurality 220₁. In the illustrated example, incisions 224 are substantially perpendicular to faces 148₁, 148₂, and make faces 148₃, 148₄ in the resulting potato stick 228. As shown, faces 148₃, 148₄ may have a wavy profile defined by the peaks 140 and valleys 144 of the disc blades 116 that cut these faces 148₃, 148₄.

Still referring to FIG. 10, each potato stick 228 may have an upstream end 232, a downstream end 236, and four sides 148₁-148₄. The four sides 148₁-148₄ were made by the incisions of two different disc blades 116 of the first plurality 220₁ of disc blades 116 and by two different disc blades 116 of the second plurality 220₂ of disc blades 116.

Except for rotational orientation, the second plurality 220₂ of disc blades 116 may be substantially identical to the first plurality of disc blades 116. For example, the second plurality 220₂ may have the same number of disc blades 116, the same spacing between adjacent disc blades 116 in a row 208, size (e.g. radius) of disc blades 116, and the same wavy profile in the disc blades 116 (e.g. amplitudes and wavelengths) as the first plurality 220₁. This may provide uniformity between the incisions made by the first plurality 220₁ and the second plurality 220₂. In some examples, each row 208 may include 2-50 disc blades 116, such as for example, 3-10 disc blades 116.

In alternative embodiment, there may be differences between the second plurality 220₂ of disc blades 116 and the first plurality 220₁ of disc blades 116. For example, the second plurality 220₂ of disc blades 116 may differ from the first plurality 220₁ of disc blades 116 in one or more of number of disc blades 116, spacing between adjacent disc blades 116 in a row 208, size (e.g. radius) of disc blades 116, and wavy profile in the disc blades 116 (e.g. amplitudes and wavelengths).

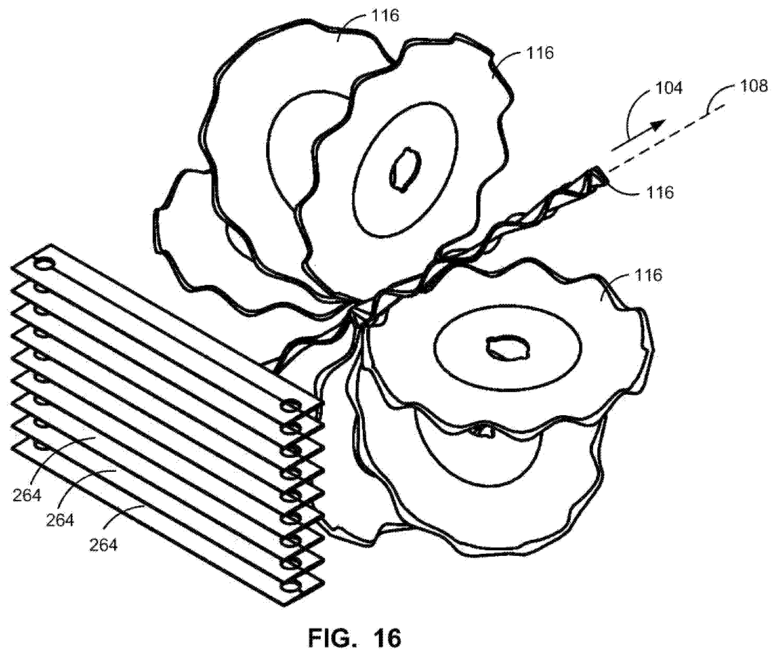

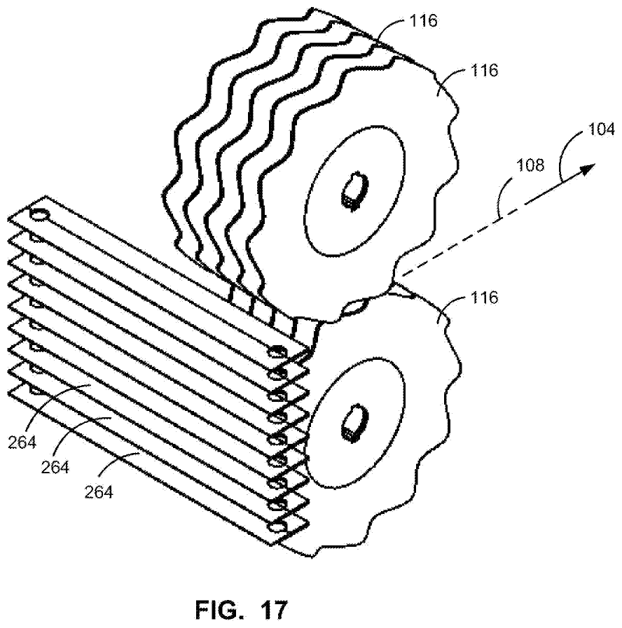

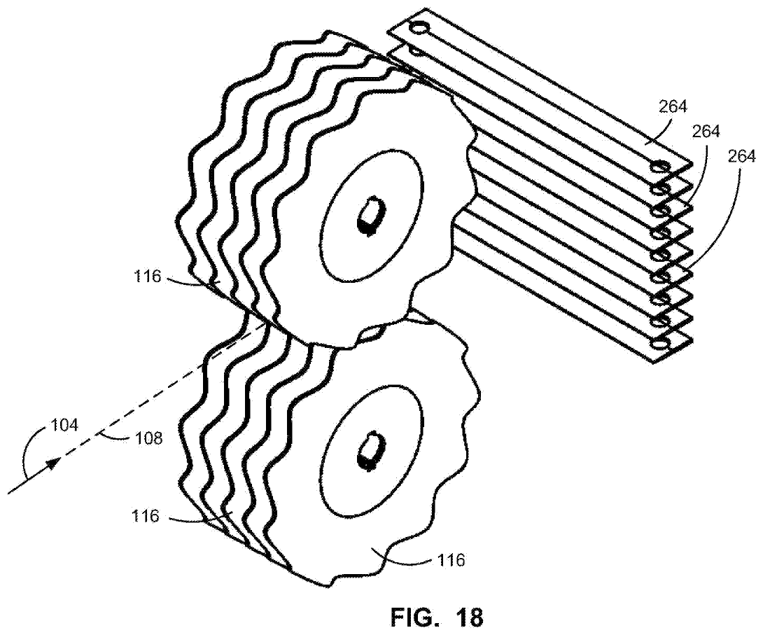

FIGS. 16-18 show blade arrangements for other embodiments of food cutter 100 (FIG. 1). The disc blade carrier and blade axles are not shown to avoid obscuring the visibility of the blades. As shown, in some embodiments, food cutter 100 (FIG. 1) may include one or more stationary blades 264 in addition to rotary disc blades 116. This allows food cutter 100 (FIG. 1) to make additional cuts into a passing food item. The stationary blades 264 can be in any number (e.g. 1-50 blades), arrangement (e.g. arrayed, parallel, or non-parallel), position (e.g. upstream, downstream, or collocated with the rotary blades 116), and shape (e.g. straight or wavy). The illustrated examples show parallel arrays of straight stationary blades 264. FIGS. 16-17 show stationary blades positioned upstream of rotary blades 116. FIG. 18 shows stationary blades positioned downstream of rotary blades 116.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1: A food cutter having a food travel axis, the food cutter comprising:
a blade carrier; and
a plurality of disc blades mounted to the blade carrier,
   each of the plurality of disc blades defining a corresponding blade rotation axis, each disc blade being rotatable relative to the blade carrier about the corresponding blade rotation axis, the corresponding blade rotation axis of the disc blade being perpendicular to and offset from the food travel axis,
   each disc blade having a perimeter edge at a constant radius from the corresponding blade rotation axis,
   the perimeter edge of each disc blade having a series of alternating peaks and valleys, each peak and valley having an amplitude in a direction parallel to the corresponding blade rotation axis.
      Item 2: The food cutter of any preceding item, wherein the perimeter edge of each disc blade abuts the perimeter edge of at least one other disc blade.

Item 3: The food cutter of any preceding item, wherein the perimeter edge of each disc blade abuts the food travel axis.

Item 4: The food cutter of any preceding item, wherein:
the plurality of disc blades includes a first disc blade and a second disc blade, and
the second disc blade is positioned downstream of the first disc blade.
   Item 5: The food cutter of any preceding item, wherein each disc blade is freely rotatable relative to the blade carrier about the corresponding blade rotation axis.
   Item 6: The food cutter of any preceding item, wherein:
the plurality of disc blades includes a first disc blade, and
the first disc blade is drivingly coupled to a rotary driver.
   Item 7: The food cutter of any preceding item, wherein the plurality of disc blades includes a circular arrangement of disc blades surrounding the food travel axis.
   Item 8: The food cutter of any preceding item, wherein the circular arrangement of disc blades comprises at least three disc blades.
   Item 9: The food cutter of any preceding item, wherein the circular arrangement of disc blades are evenly distributed along an imaginary circle that surrounds the food travel axis.
   Item 10: The food cutter of any preceding item, wherein the perimeter edge of each disc blade in the circular arrangement of disc blades is abutting the perimeter edge of each other disc blade in the circular arrangement of disc blades.
   Item 11: The food cutter of any preceding item, wherein the perimeter edge of each disc blade in the circular arrangement of disc blades is abutting the food travel axis.
   Item 12: The food cutter of any preceding item, wherein the perimeter edge of each disc blade has the same number of peaks and valleys.
   Item 13: The food cutter of any preceding item, wherein the plurality of disc blades includes at least a first row of disc blades and a second row of disc blades.
   Item 14: The food cutter of any preceding item, wherein:
the blade rotation axis of each disc blade in the first row of disc blades is collinear with the blade rotation axis of each other disc blade in the first row of disc blades, and
the blade rotation axis of each disc blade in the second row of disc blades is collinear with the blade rotation axis of each other disc blade in the second row of disc blades.
   Item 15: The food cutter of any preceding item, wherein:
the perimeter edge of each disc blade in the first row of disc blades abuts the perimeter edge of a respective disc blade in the second row of disc blades.
   Item 16: The food cutter of any preceding item, wherein:
the blade rotation axis of each disc blade in the first row of disc blades is parallel with the blade rotation axis of each disc blade in the second row of disc blades.
   Item 17: The food cutter of any preceding item, wherein:
the plurality of disc blades includes at least a third row of disc blades and a fourth row of disc blades,
the blade rotation axis of each disc blade in the third row of disc blades is collinear with the blade rotation axis of each other disc blade in the third row of disc blades,
the blade rotation axis of each disc blade in the fourth row of disc blades is collinear with the blade rotation axis of each other disc blade in the fourth row of disc blades,
the perimeter edge of each disc blade in the third row of disc blades abuts the perimeter edge of a respective disc blade in the fourth row of disc blades, and
the blade rotation axis of each disc blade in the third and fourth rows of disc blades is non-parallel with the blade rotation axis of each disc blade in the first and second rows of disc blades.
   Item 18: The food cutter of any preceding item, wherein:
the blade rotation axis of each disc blade in the third and fourth rows of disc blades is perpendicular to the blade rotation axis of each disc blade in the first and second rows of disc blades.
   Item 19: The food cutter of any preceding item, wherein:
the third and fourth rows of disc blades are positioned downstream of the first and second rows of disc blades.
   Item 20: A food cutter having a food travel axis, the food cutter comprising:
a blade carrier; and
a plurality of disc blades mounted to the blade carrier,
   each of the plurality of disc blades defining a corresponding blade rotation axis, each disc blade being rotatable relative to the blade carrier about the corresponding blade rotation axis, the corresponding blade rotation axis of the disc blade being perpendicular to and offset from the food travel axis,
   each disc blade having a perimeter edge at a constant radius from the corresponding blade rotation axis,
   each of the plurality of disc blades having a corresponding incision axis that is parallel to the food travel axis and tangent to the perimeter edge of the disc blade,
   wherein the incision axis of each of the plurality of disc blades is substantially collinear with the incision axis of at least one other of the plurality of disc blades.
      Item 21: The food cutter of any preceding item, wherein each disc blade is freely rotatable relative to the blade carrier about the corresponding blade rotation axis.
      Item 22: The food cutter of any preceding item, wherein:
the plurality of disc blades includes a first disc blade, and
the first disc blade is drivingly coupled to a rotary driver.
   Item 23: The food cutter of any preceding item, wherein:
the plurality of disc blades includes a first disc blade and a second disc blade, and
the perimeter edge of the first disc blade abuts the perimeter edge of the second disc blade.
   Item 24: The food cutter of any preceding item, wherein:
the plurality of disc blades includes a first disc blade and a second disc blade, and
the second disc blade is positioned downstream of the first disc blade.
   Item 25: The food cutter of any preceding item, wherein the plurality of disc blades includes a circular arrangement of disc blades surrounding the food travel axis.
   Item 26: The food cutter of any preceding item, wherein the circular arrangement of disc blades comprises at least 3 disc blades.
   Item 27: The food cutter of any preceding item, wherein the circular arrangement of disc blades are evenly distributed along an imaginary circle that surrounds the food travel axis.
   Item 28: The food cutter of any preceding item, wherein the perimeter edge of each disc blade in the circular arrangement of disc blades is abutting the perimeter edge of each other disc blade in the circular arrangement of disc blades.
   Item 29: The food cutter of any preceding item, wherein the perimeter edge of each disc blade in the circular arrangement of disc blades is abutting the food travel axis.
   Item 30: The food cutter of any preceding item, wherein the perimeter edge of each disc blade has the same number of peaks and valleys.
   Item 31: The food cutter of any preceding item, wherein the plurality of disc blades includes at least a first row of disc blades and a second row of disc blades.
   Item 32: The food cutter of any preceding item, wherein:
the blade rotation axis of each disc blade in the first row of disc blades is collinear with the blade rotation axis of each other disc blade in the first row of disc blades, and
the blade rotation axis of each disc blade in the second row of disc blades is collinear with the blade rotation axis of each other disc blade in the second row of disc blades.
   Item 33: The food cutter of any preceding item, wherein:
the incision axis of each disc blade in the first row of disc blades is substantially collinear with the incision axis of a respective disc blade in the second row of disc blades.
   Item 34: The food cutter of any preceding item, wherein:
the perimeter edge of each disc blade in the first row of disc blades abuts the perimeter edge of a respective disc blade in the second row of disc blades.
   Item 35: The food cutter of any preceding item, wherein:
the blade rotation axis of each disc blade in the first row of disc blades is parallel with the blade rotation axis of each disc blade in the second row of disc blades.
   Item 36: The food cutter of any preceding item, wherein:
the plurality of disc blades includes at least a third row of disc blades and a fourth row of disc blades,
the blade rotation axis of each disc blade in the third row of disc blades is collinear with the blade rotation axis of each other disc blade in the third row of disc blades,
the blade rotation axis of each disc blade in the fourth row of disc blades is collinear with the blade rotation axis of each other disc blade in the fourth row of disc blades,
the perimeter edge of each disc blade in the third row of disc blades abuts the perimeter edge of a respective disc blade in the fourth row of disc blades, and
the blade rotation axis of each disc blade in the third and fourth rows of disc blades is non-parallel with the blade rotation axis of each disc blade in the first and second rows of disc blades.
   Item 37: The food cutter of any preceding item, wherein:
the blade rotation axis of each disc blade in the third and fourth rows of disc blades is perpendicular to the blade rotation axis of each disc blade in the first and second rows of disc blades.
   Item 38: The food cutter of any preceding item, wherein:
the third and fourth rows of disc blades are positioned downstream of the first and second rows of disc blades.
   Item 39: A method of cutting food into food pieces, the method comprising:
moving a food item in a downstream direction along a food travel axis toward a plurality of rotatable disc blades,
   wherein the food item strikes the plurality of disc blades, wherein each disc blade defines a corresponding blade rotation axis;
   wherein each disc blade penetrates the food item, each disc blade having a perimeter edge with a series of alternating peaks and valleys,
   each peak and valley having an amplitude in a direction parallel to the corresponding blade rotation axis,
moving the food item downstream through the plurality of disc blades;
wherein each disc blade in the plurality of disc blades is rotated as the food item moves through the plurality of disc blades; and
cutting the food item into food pieces by incisions made by the plurality of disc blades by moving the food item through the plurality of disc blades.
   Item 40: The method of any preceding item, wherein:
each disc blade is freely rotatable about a respective blade rotation axis, and
each disc blade is rotated at a blade rotation speed governed by interaction between: (i) the food item, and (ii) the peaks and valleys of each disc blade that pierce the food item.
   Item 41: The method of any preceding item, wherein:
each disc blade is rotated about its corresponding blade rotation axis by a rotary driver.
   Item 42: The method of any preceding item, wherein:
in moving the food item downstream through the plurality of disc blades, each disc blade forms an incision in the food item with a terminal end in an interior of the food item, and
the incision formed by each disc blades cooperates with the incision formed by at least one other disc blade to divide the food item into food pieces.
   Item 43: The method of any preceding item, wherein:
the terminal end of the incision formed by each disc blade abuts the terminal end of the incision formed by at least one other disc blade.
   Item 44: The method of any preceding item, wherein:
in moving the food item downstream through the plurality of disc blades, each disc blade forms an incision in the food item, and
the incision formed by each disc blade has a wavy profile defined by the peaks and valleys of that disc blade.
   Item 45: The method of any preceding item, wherein:
the wavy profile of each incision includes peaks and valleys that alternate in the downstream direction.
   Item 46: The method of any preceding item, wherein:
in moving the food item downstream through the plurality of disc blades, each disc blade forms an incision in the food item, and
said dividing the food item into food pieces comprises dividing the food item into a plurality of wedges, each wedge having a first face intersecting a second face at a wedge apex, each of the first and second faces having been made by the incision formed by a different one of the plurality of disc blades.
   Item 47: The method of any preceding item, wherein:
each of the first and second faces of each wedge has a wavy profile defined by the peaks and valleys of the disc blade that formed the incision that made each face.
   Item 48: The method of any preceding item, wherein:
the wavy profile of each of the first and second faces includes peaks and valleys that alternate in the downstream direction.
   Item 49: The method of any preceding item, wherein:
the food pieces are food slices, and
the method further comprises
   striking a second plurality of disc blades with the food slices,
   moving the food slices downstream through the second plurality of disc blades;
   wherein each disc blade in the second plurality of disc blades is rotated as the food slices move through the second plurality of disc blades, wherein each disc blade in the second plurality of disc blades is rotated at a blade rotation speed governed by interaction between: (i) the food slices and (ii) the peaks and valleys of each disc blade that pierce the food item; and
   cutting the food slices into food sticks by incisions made by the second plurality of disc blades by moving the food item through the plurality of disc blades.
      Item 50: The method of any preceding item, wherein:
the plurality of disc blades is a first plurality of disc blades,
the incisions made by the first plurality of disc blades are substantially parallel,
the incisions made by the second plurality of disc blades are substantially parallel, and
the incisions made by the first plurality of disc blades are non-parallel to the incisions made by the second plurality of disc blades.
   Item 51: The method of any preceding item, wherein:
the incisions made by the first plurality of disc blades are substantially perpendicular to the incisions made by the second plurality of disc blades.
   Item 52: The method of any preceding item, wherein:
each food stick has an upstream end, a downstream end, and four sides each extending from the upstream end to the downstream end, and
the four sides of each food stick were made by the incisions of two different disc blades of the first plurality of disc blades and by two different disc blades of the second plurality of disc blades.
   Item 53: The method of any preceding item, wherein:
each food stick has an upstream end, a downstream end, and four sides each extending from the upstream end to the downstream end, and
each of the four sides of each food stick has a wavy profile including peaks and valleys that alternate in the downstream direction.
   Item 54: The method of any preceding item, wherein:
each disc blade is freely rotatable about a respective blade rotation axis, and
the blade rotation axis of each disc blade is perpendicular to and offset from the food travel axis.
   Item 55: The method of any preceding item, wherein:
the perimeter edge of each disc blade is at a constant radius from a blade rotation axis of that disc blade.
   Item 56: The method of any preceding item, wherein:
the perimeter edge of each disc blade abuts the perimeter edge of at least one other disc blade.
   Item 57: A method of cutting food into food pieces, the method comprising:
moving a food item in a downstream direction along a food travel axis toward a plurality of rotatable,
   wherein the food item strikes the plurality of disc blades, wherein each disc blade defines a corresponding blade rotation axis;
   wherein each disc blade penetrates the food item,
   wherein each disc blade has a perimeter edge at a constant radius from a blade rotation axis,
moving the food item downstream through the plurality of disc blades; and
cutting the food item into food pieces by incisions made by the plurality of disc blades by moving the food item through the plurality of disc blades, each disc blade forming an incision in the food item with a terminal end in an interior of the food item, and the terminal end of each incision abutting the terminal end of an incision formed by at least one other of the plurality of disc blades.
   Item 58: The method of any preceding item, wherein:
the perimeter edge of each disc blade abuts the perimeter edge of at least one other disc blade.
   Item 59: The method of any preceding item, wherein:
the incision formed by each disc blades cooperates with the incision formed by at least one other disc blade to divide the food item into food pieces.
   Item 60: The method of any preceding item, wherein:
the incision formed by each disc blade has a wavy profile that includes peaks and valleys that alternate in the downstream direction.

1. A food cutter having a food travel axis, the food cutter comprising:
a blade carrier; and
a plurality of disc blades mounted to the blade carrier,
each of the plurality of disc blades defining a corresponding blade rotation axis, each disc blade being rotatable relative to the blade carrier about the corresponding blade rotation axis, the corresponding blade rotation axis of the disc blade being perpendicular to and offset from the food travel axis,
each disc blade having a perimeter edge at a constant radius from the corresponding blade rotation axis,
the perimeter edge of each disc blade having a series of alternating peaks and valleys, each peak and valley having an amplitude in a direction parallel to the corresponding blade rotation axis.

2. The food cutter of claim 1, wherein the perimeter edge of each disc blade abuts the perimeter edge of at least one other disc blade.

3. The food cutter of claim 1, wherein the perimeter edge of each disc blade abuts the food travel axis.

4. The food cutter of claim 1, wherein:
the plurality of disc blades includes a first disc blade and a second disc blade, and
the second disc blade is positioned downstream of the first disc blade.

5. The food cutter of claim 1, wherein each disc blade is freely rotatable relative to the blade carrier about the corresponding blade rotation axis.

6. The food cutter of claim 1, wherein:
the plurality of disc blades includes a first disc blade, and
the first disc blade is drivingly coupled to a rotary driver.

7. The food cutter of claim 1, wherein the plurality of disc blades includes a circular arrangement of disc blades surrounding the food travel axis.

8. The food cutter of claim 7, wherein the circular arrangement of disc blades comprises at least three disc blades.

9. The food cutter of claim 7, wherein the circular arrangement of disc blades are evenly distributed along an imaginary circle that surrounds the food travel axis.

10. The food cutter of claim 7, wherein the perimeter edge of each disc blade in the circular arrangement of disc blades is abutting the perimeter edge of each other disc blade in the circular arrangement of disc blades.

11. The food cutter of claim 7, wherein the perimeter edge of each disc blade in the circular arrangement of disc blades is abutting the food travel axis.

12. The food cutter of claim 1, wherein the perimeter edge of each disc blade has the same number of peaks and valleys.

13. The food cutter of claim 1, wherein the plurality of disc blades includes at least a first row of disc blades and a second row of disc blades.

14. The food cutter of claim 13, wherein:
the blade rotation axis of each disc blade in the first row of disc blades is collinear with the blade rotation axis of each other disc blade in the first row of disc blades, and
the blade rotation axis of each disc blade in the second row of disc blades is collinear with the blade rotation axis of each other disc blade in the second row of disc blades.

15. The food cutter of claim 13, wherein:
the perimeter edge of each disc blade in the first row of disc blades abuts the perimeter edge of a respective disc blade in the second row of disc blades.

16. The food cutter of claim 13, wherein:
the blade rotation axis of each disc blade in the first row of disc blades is parallel with the blade rotation axis of each disc blade in the second row of disc blades.

17. The food cutter of claim 13, wherein:
the plurality of disc blades includes at least a third row of disc blades and a fourth row of disc blades,
the blade rotation axis of each disc blade in the third row of disc blades is collinear with the blade rotation axis of each other disc blade in the third row of disc blades,
the blade rotation axis of each disc blade in the fourth row of disc blades is collinear with the blade rotation axis of each other disc blade in the fourth row of disc blades,
the perimeter edge of each disc blade in the third row of disc blades abuts the perimeter edge of a respective disc blade in the fourth row of disc blades, and
the blade rotation axis of each disc blade in the third and fourth rows of disc blades is non-parallel with the blade rotation axis of each disc blade in the first and second rows of disc blades.

18. The food cutter of claim 17, wherein:
the blade rotation axis of each disc blade in the third and fourth rows of disc blades is perpendicular to the blade rotation axis of each disc blade in the first and second rows of disc blades.

19. The food cutter of claim 17, wherein:
the third and fourth rows of disc blades are positioned downstream of the first and second rows of disc blades.
